(19) United States
(12) Patent Application Publication
(10) Pub. No.: US 2026/0095757 A1
(43) Pub. Date: Apr. 2, 2026

(54) EMBEDDED SUBSCRIBER IDENTITY MODULE RECOVERY WHEN SOURCE DEVICE IS NON-FUNCTIONAL

(71) Applicant: Apple Inc., Cupertino, CA (US)

(72) Inventors: Raj S Chaugule, Santa Clara, CA (US); Suraj Gupta, Cupertino, CA (US); Jean-Marc Padova, San Francisco, CA (US); Daniel C Underwood, Cupertino, CA (US); Sherman X Jin, Santa Clara, CA (US); Florent Renahy, West Vancover (CA)

(21) Appl. No.: 18/900,515

(22) Filed: Sep. 27, 2024

(51) Int. Cl. H04W 8/30; H04W 8/20; H04W 12/069

(52) U.S. Cl. CPC H04W 8/30; H04W 8/205; H04W 12/084

(57) ABSTRACT

A user equipment (UE), baseband processor, and network device are described for embedded subscriber identity module (eSIM) recovery for non-functional devices. The UE (e.g., a source UE) can perform transmitting, to a custodian UE, a request for the custodian UE to perform as a custodian device of a recovery token for an eSIM of the source UE, and receive an acceptance of the custodian UE as the custodian device. The source UE may then obtain the recovery token from a remote server, the recovery token including a first token and a second token, and transmit the first token to the custodian UE and transmit the second token to a cloud service account associated with both the source UE and the custodian UE. Later, a target UE may request the first token from the custodian and the second token from the cloud service account for an eSIM transfer procedure.

### TECHNICAL FIELD

This application relates generally to wireless communication systems, including systems, apparatuses, and methods of embedded subscriber identity module (eSIM) recovery when a source device is non-functional.

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an E-UTRAN Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE DRAWINGS

To easily identify the discussion of any particular element or act, the most significant digit or digits in a reference number refer to the figure number in which that element is first introduced.

FIG. 1 shows an example wireless communication system, according to one or more aspects described herein.

FIG. 2 shows an example device change procedure, according to one or more aspects described herein.

FIG. 3 shows an example signaling flow, according to one or more aspects described herein.

FIG. 4 shows an example signaling flow, according to one or more aspects described herein.

FIG. 5 shows an example signaling flow, according to one or more aspects described herein.

FIG. 6 shows an example signaling flow, according to one or more aspects described herein.

FIG. 7 shows an example method of wireless communication at a source user equipment (UE), according to one or more aspects described herein.

FIG. 8 shows another example method of wireless communication at a target UE, according to one or more aspects described herein.

FIG. 9 illustrates an example architecture of a wireless communication system, according to one or more aspects described herein.

FIG. 10 illustrates an example system for performing signaling between a wireless device and a network device, according to one or more aspects described herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

A UE or other mobile device may use a subscriber identity module (SIM) card to store information about a user of the UE. Rather than a physical, removable card to be changed out or installed for different deployments, an eSIM (embedded SIM) may be embedded directly into a UE, such as a smartphone or Internet of Things (IoT) device. The term eSIM, as used herein, refers generally to remote SIM provisioning according to the Global System for Mobile Communications Association (GSMA). The eSIM is designed in part to replace traditional physical SIM cards. One advantage of eSIM technology is flexibility. For example, eSIM technology allows users to remotely provision and manage the user's mobile subscriptions without the need for a physical SIM card swap.

A user of a device (e.g., a UE, such as a mobile device) may decide to change their device (the source device) to a new device (the target device). In some systems, where the source device uses an eSIM and the devices are to be used with a same cellular carrier (e.g., a same cellular network operator), a transfer token may be generated by the source device, and then provided to the target device during the device change (e.g., during authorization and/or initialization portions of the device change flow). For example, the transfer token may be sent from the source device to the target device using a short-range wireless communication standard (e.g., Bluetooth®). Such transfer token identifies security information association with the source device and eSIM, allowing a user to provide the transfer token to the cellular carrier from the target device. Having received and determined that the token is valid, the cellular carrier then provides an eSIM to the target device, thus allowing transfer of the eSIM from the source device to the target device. However, such procedures use a present source device, for example according to a procedure of the Global System for Mobile Communications Association (GSMA) in the TS.43 specification. As such, if the source device is lost, stolen, broken, or otherwise unavailable, the device change token cannot be generated or retrieved, and an offline process with the cellular carrier may be required to obtain the eSIM for the target device. The offline process consumes time and resources of the user, the cellular carrier, and other entities.

Techniques are described herein to allow for recovery of a source device's eSIM at a target device (e.g., a target UE), without the availability of the source device (e.g., a source UE). A recovery token may be issued by a remote server (e.g., an entitlement server) to allow the transfer of a user's eSIM to a new device (e.g., from a source UE to a target UE). A custodian device may be used to escrow a first token (e.g., a static token or static portion) of the recovery token for later use by the target device. A cloud service account of the user of the source UE and the target UE may be used to store a second token (e.g., a dynamic token or dynamic portion) of the recovery token. The second token of the recovery token may be periodically refreshed at the cloud service account. After the source UE becomes unavailable, the target UE may obtain the first token from the custodian device and the second token from the cloud service account of the user, and the complete recovery token assembled from the first token and the second token. The cloud service account may be associated with both the source device and the custodian device. The eSIM may be transferred to the target UE during the device change procedure by providing the recovery token to the remote server.

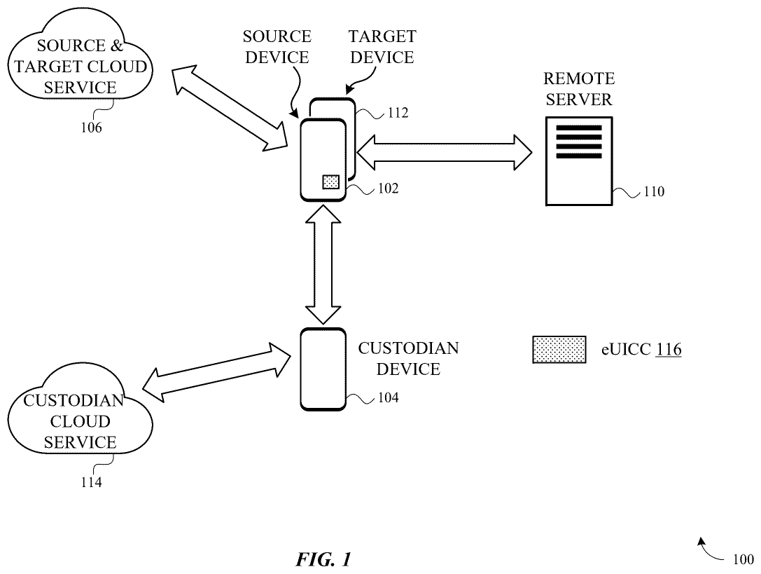

FIG. 1 shows an example wireless communications system 100, according to one or more aspects described herein. In one or more embodiments, wireless communications system 100 supports one or more aspects of eSIM recovery when a source device is non-functional, as further described herein.

Wireless communications system 100 includes a source device 102 and a target device 112, each or both of which may be UEs, as further described herein. For example, where a source device 102 is described herein, such source device 102 may be a UE (e.g., a source UE). Additionally or alternatively, where a target device 112 is described herein, such target device 112 may be a UE (e.g., a target UE). The source device 102 and the target device 112 are connected (e.g., via one or more wired or wireless access devices) to a cloud-based service 106. The source device 102 and the target device 112 are capable of operating in a network operated by a cellular carrier, for example via a wireless connection to one or more network devices (e.g., base stations) that provide wireless connectivity for the source device 102 and the target device 112.

The source device 102, for example during a first time duration, may have an eSIM provisioned for a user, for example the eSIM installed at an eUICC 116 of the source device 102. At a later time (a second time duration), for example after the user acquires the target device that the user desires to operate in a cellular network of the cellular carrier, the eSIM may have transferred to the target device 112, where the user may desire to install the eSIM at an eUICC of the target device 112. However, the source device 102 may be unavailable to the user. For example, the source device 102 may be lost, stolen, damaged, destroyed, powered off, or otherwise unavailable. The procedures and features described herein, while providing (among other things) the advantage of allowing efficient eSIM transfer to the target device 112 when the source device 102 is unavailable, may also be used when the source device 102 is available.

As further described herein, a token pair including a static token and a dynamic token may be used, where neither token alone is sufficient to be used on its own to recover an eSIM at (or transfer an eSIM to) a target device. Additionally, the static token can be generated and/or retrieved by the original source device with added on-device security, such as a “trusted user intent” mechanism rooted in the device hardware or by utilizing a biometric user challenge to protect against zero-touch attacks. In some examples, the trusted user intent generates a trusted signature from the eUICC that authorizes the generation and release of the static token. A custodian device 104 (e.g., a trusted custodian device and/or OEM cloud security) operates to protect the static token. The custodian device 104 is connected (e.g., via one or more wired or wireless access devices) to a cloud-based service 114. Additionally, the trusted custodian setup described herein may use a trusted user intent on a source device and verification on a remote server (e.g., a carrier server). Additionally, the dynamic token may be escrowed in a hardware security module, which is secured (backed) by a source device passcode. As further described (e.g., with reference to signaling flow 500), the dynamic token may utilize a refresh mechanism to keep the dynamic token relatively short-lived. In one or more examples, end-to-end encryption may be used to communicate between the custodian device 104, source device 102, and target device 112. In some examples, integrity verification that the custodian device 104 is correctly identified by the source device 102 as the custodian of the static token may be done by using an original equipment manufacturer (OEM) cloud account (e.g., OEM cloud services framework). As further described below, the remote server 110 verifies both the static token and the dynamic token together to allow the eSIM transfer to occur. Where a custodian device 104 is described herein, such custodian device 104 may be a UE (e.g., custodian UE).

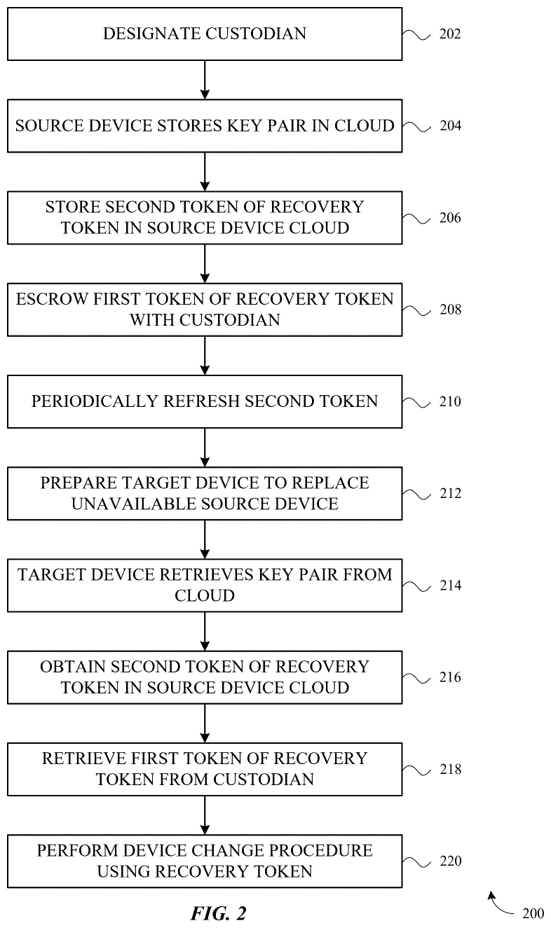

FIG. 2 shows an example device change procedure 200, according to one or more aspects described herein. In one or more embodiments, device change procedure 200 supports one or more aspects of eSIM recovery when a source device is non-functional, as further described herein. The device change procedure 200 may use devices described with reference to wireless communications system 100.

The device change procedure 200 includes, among other aspects, at 202, designating a custodian device 104 (e.g., a custodian UE). The custodian device may be selected by the source device 102 to act as a custodian of (escrow) a portion of a recovery token on behalf of the source device 102.

At 204, the source device 102 generates a key pair comprising a public key and a private key, and transmits the key pair to the cloud-based service 106 for storage (e.g., in a keychain of the source device 102). The source device 102 may request a recovery token from the cellular carrier for the eSIM of the source device 102. The cellular carrier may operate a remote server (e.g., remote server 110) for such purposes, though any server the cellular network manages and provides recovery tokens may be used consistent with the techniques described herein.

At 206, the source device 102 may transmit a first token of the recovery token to the cloud service of the custodian device 104 for storage. At 208, the custodian device 104 may transmit a second token of the recovery token to the custodian device 104 for storage. In some examples, the first token of the recovery token may be a static token of the recovery token, and the second token of the recovery token may be a dynamic token of the recovery token. In some examples, a dynamic portion of the recovery token may be, or be referred to, as a dynamic token. The static portion of the recovery token may be, or be referred to, as a static token. Collectively, the first token and the second token (or the static token and the dynamic token) are the recovery token, for example when the first token and the second token are presented together.

At 210, the second token of the recovery token may be periodically refreshed, as further described herein. Periodically refreshing the second token of the recovery token may increase security of the recovery token overall, for example by decreasing the risk that a recovery token that is compromised may be utilized by an attacker. For example, each time the second token of the recovery token is refreshed, the recovery token effectively become a new token, without the need to update the entire recovery token. Updating the entire recovery token may create a burden on the custodian device or otherwise be challenging to implement with the custodian device.

In some examples, when the second token is to be refreshed, a refresh request may be transmitted to the remote server (e.g., an entitlement server). In some examples, a request for a recovery token includes an eUICC signature, in which cases the remote server returns a recovery token including both the first (static) token and the second (dynamic) token. However, to refresh the second (dynamic) token, the request sent to the remote server may lack an eUICC signature. As such, in response to the refresh request, the remote server may provide the second (dynamic) token, and not the first (static) token. In other words, in some examples, without the eUICC signature, the remote (entitlement) server will provide the second token, but not the first token. This refresh process may happen in the background, and the user may not need to provide an indication of the trust user intent.

At 212, a target device 112 (e.g., a target UE) may be prepared to replace the source device (e.g., source device 102), which may be unavailable (e.g., lost, stolen, damaged, etc.). In some examples the user of the target device is a same user as the user of the source device. As such, the user, and by extension the target device, may have access to the cloud-based service 106 of the source device 102. At 214, the target device 112 retrieves the key pair from the cloud-based service 106 that was generated at 204, including the public key and the private key.

At 216, the target device 112 obtains the second token (e.g., the dynamic part) of the recovery token from the cloud of the source device 102, which is accessible to the target device 112, as described herein. At 218, the target device 112 obtains the first token (e.g., the static part) of the recovery token from the custodian device 104 (e.g., a custodian UE). The target device 112 may thereafter have a complete recovery token including both the first token and the second token.

At 220, the target device 112 may then initiate a device transfer by providing the recovery token to the remote server 110, and the device change procedure may continue. The target device 112, based on having provided a valid recovery token to the remote server 110, may then be allowed to download the eSIM of the source device 102 to the target device 112 and go on to complete the device change procedure.

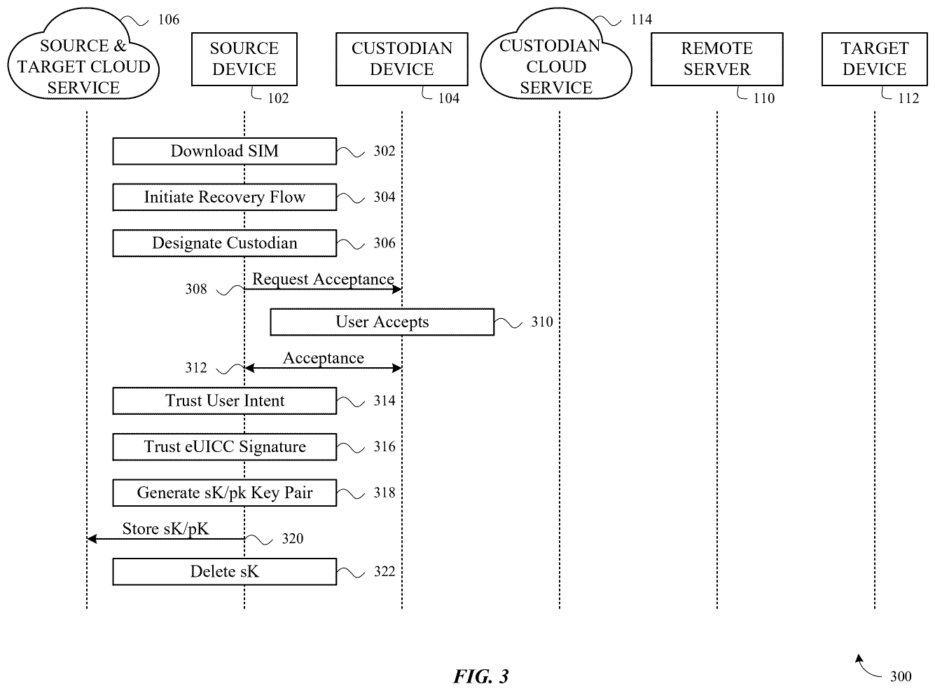

FIG. 3 shows an example signaling flow 300, according to one or more aspects described herein. In one or more embodiments, signaling flow 300 supports one or more aspects of eSIM recovery when a source device is non-functional, as further described herein. Signaling flow 300 generally shows aspects of generating and storing (escrowing) a recovery transfer token for an eSIM.

Signaling flow 300 includes communications between one or more of the source device 102, the cloud-based service 106 for the source device, and the custodian device 104. The cloud service 114 for the custodian device 104, the remote server 110, and the target device 112 are shown for reference.

At 302, a source device 102 may download an eSIM for the source device 102 to use to communication in a wireless communications network. As further described herein, it may be desirable to escrow a recovery token so that, if the source device 102 becomes unavailable, the eSIM may be transitioned to a new device (the target device 112) and the transfer process completed more quickly and with less inconvenience. At 304, a recovery flow may be initiated, the recovery flow including obtaining and escrowing the recovery token for later use.

At 306, the source device 102, designates a custodian (e.g., custodian device 104) for the recovery token. In some examples the source device 102 designates the custodian, such as a custodian OEM cloud account, such that, at 308, the source device 102 may request the custodian's acceptance. At 310, the custodian device 104 and specifically a user of the custodian device 104 may accept the custodian device 104 as a custodian. At acceptance 312, the source device 102 and custodian device 104 may exchange messages to establish the custodian device 104 as custodian.

At 314, the source device 102 may receive input from a user indicating that the custodian device 104 is intended to be a trusted user. At 316, the source device 102 generates a trusted eUICC signature.

At 318, the source device 102 generates a key pair including a private key (sK) and a public key (pK). At 320, the source device 102 transmits the key pair to the cloud-based service 106 of the user of the source device 102. The cloud-based service 106 may then store each of the private key and the public key of the key pair, for example, to be later accessed by the user via the target device 112, for example after the source device 102 become unavailable. The private key may be protected by a device passcode (e.g., a passcode of the source device 102). After the private key and the public key are stored at the cloud-based service 106, the source device 102 deletes the private key at 322.

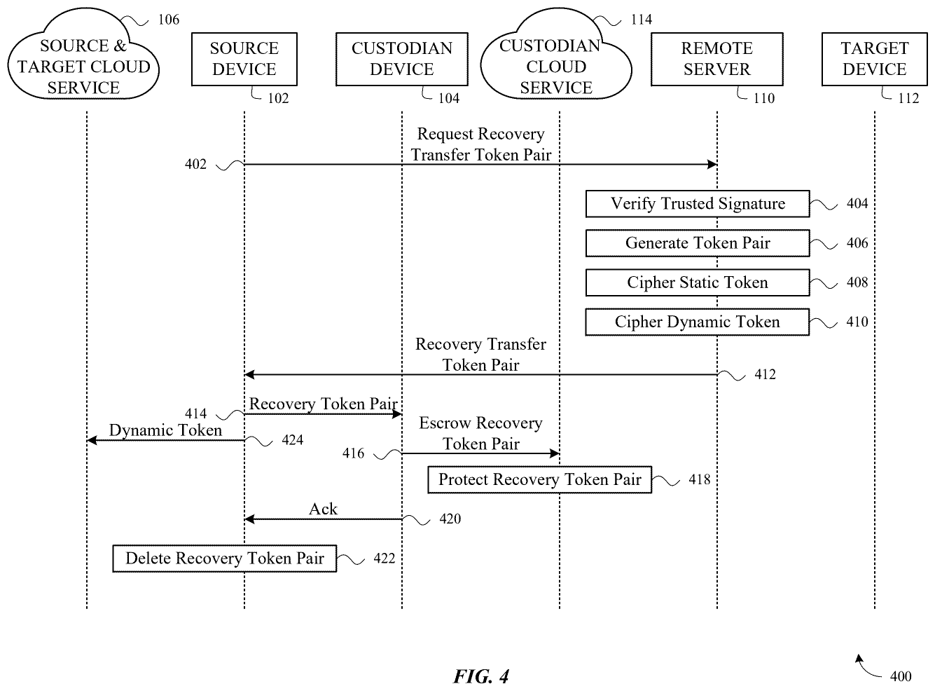

FIG. 4 shows an example signaling flow 400, according to one or more aspects described herein. In one or more embodiments, signaling flow 400 supports one or more aspects of eSIM recovery when a source device is non-functional, as further described herein. Signaling flow 400 generally shows further aspects of generating and storing (escrowing) a recovery transfer token for an eSIM, in addition to those aspects discussed with reference to signaling flow 300.

Signaling flow 400 includes communications between one or more of the source device 102, the custodian device 104, the cloud service 114 for the custodian device 104, and the remote server 110. The cloud-based service 106 and the target device 112 are shown for reference.

At 402 (which follows 322 of the signaling flow 300), the source device 102 may transmit a request for a recovery token to the remote server 110. In one or more embodiments, the recovery token may be a pair of tokens that includes a first token (e.g., a static token) and a second token (e.g., a dynamic token), such that the request is for the pair of tokens. The recovery token may also be referred to as a recovery transfer token or recovery transfer token pair herein. The request may include an extensible authentication protocol-authentication and key agreement (EAP-AKA) authorization token, the trusted eUICC signature (e.g., the trusted eUICC signature generated at 316), and the public key of the source device 102 (e.g., a signed pK).

At 404, the remote server 110 verifies the trusted eUICC signature. At 406, the remote server 110 generates a recovery token, including the first token (e.g., the static token) and the second token (e.g., the dynamic token). Where the recovery token is a pair of tokens, the remote server 110 generates a recovery token pair including the first token (e.g., the static token) and the second token (e.g., the dynamic token).

At 408, the remote server 110 ciphers the first token of the recovery token pair (e.g., the static token) using the public key of the source device 102 that was provided with the request at 402. At 410, (which may be before or at a same time as 408) the remote server 110 ciphers the second token of the recovery token pair (e.g., the dynamic token) using the public key of the source device 102 that was provided with the request at 402. At 412, the remote server 110 then transmits the recovery token pair that includes the ciphered first token and the ciphered second token.

At 414, the recovery token pair (e.g., including the ciphered static token and the ciphered dynamic token) may be provided from the source device 102 to the custodian device 104. At 416, the recovery token pair may be transmitted or otherwise provided to the cloud service 114 for the custodian device 104. At 418, the recovery token pair may be protected at the cloud service 114, for example by ciphering the recovery token pair using the passcode of the user of the custodian device 104. In some examples, at 424, the dynamic token may be provided to and stored in the cloud-based service 106. 424 may occur at any time following 412 and before 422.

At 420, the custodian device may provide an acknowledgment to the source device 102 indicating that recovery token is escrowed or otherwise stored at the custodian device 104 and/or the cloud service 114. At 422, the source device 102 may then proceed to delete the recovery token pair.

In some examples, following the user accepting the custodian device at 310, the custodian device 104 may generate a key pair for the custodian device that includes a public key (e.g., cust-pK) and a private key (e.g., cust-sK). The key pair for the custodian device may be saved into the cloud service for 114. In such examples, at 402, in addition to the request including an EAP-AKA authorization token, the trusted eUICC signature, and the public key of the source device 102, the request may also include the public key of the custodian device 104. In such cases, at 408, the first token (e.g., the static token) may be ciphered using the public key of the custodian device 104 and, at 410, the second token (e.g., the dynamic token) may be ciphered using the public key for the source device 102.

One or more advantages of performing the signaling flow 300 and/or the signaling flow 400 includes increased security. In some examples, security may be increased because a person (user) who owns the custodian device can consent, which may protect against zero-touch attacks. Additionally, or alternatively, security may also be increased because a private key is obtained use a passcode of the source device 102. Additionally, or alternatively, security may also be increased because the first token and/or the second token of the recovery token pair are not communicated in the clear (e.g., without encryption), and either of the first token alone or the second token alone is inadequate to transfer the eSIM. Additionally, or alternatively, security may also be increased because authorization from both the eSIM owner (e.g., the user of the source device 102 and the target device 112) and the custodian (e.g., user of the custodian device 104) are needed to perform the eSIM recovery procedure. Additionally, or alternatively, security may also be increased because an embargo time (e.g., a quantity of hours or days) can be attached to the dynamic token, such that the dynamic token cannot be retrieved during the embargo, adding friction to the recovery process to prevent misuse of the dynamic and/or static tokens.

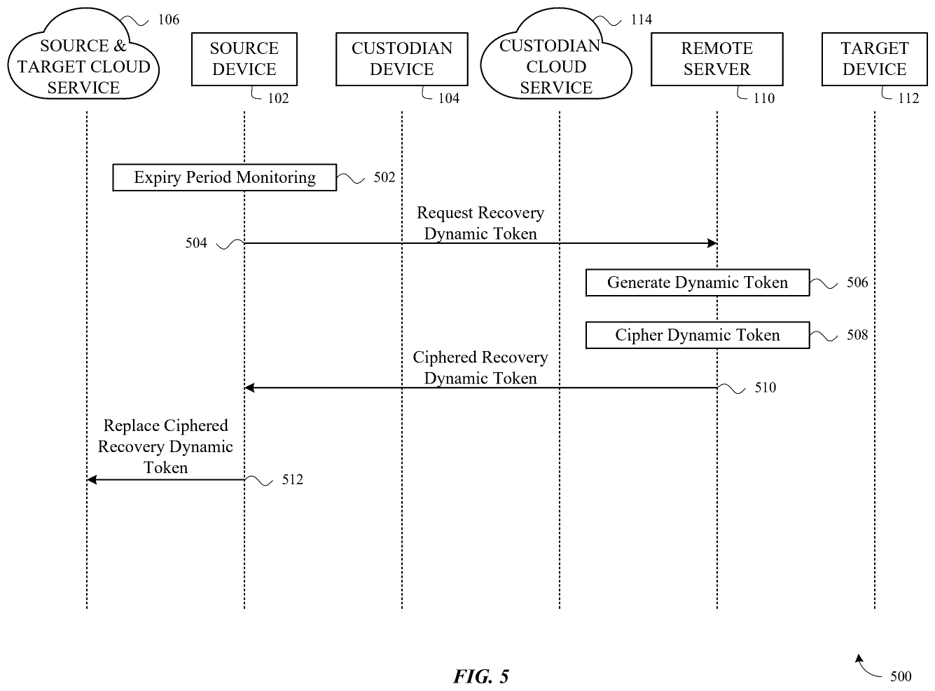

FIG. 5 shows an example signaling flow 500, according to one or more aspects described herein. In one or more embodiments, signaling flow 500 supports one or more aspects of eSIM recovery when a source device is non-functional, as further described herein. Signaling flow 500 generally shows aspects of refreshing the dynamic token of a recovery token pair. In one or more examples, signaling flow 500 generally follows the aspects described with reference to signaling flow 300 and signaling flow 400, for example once a first token (e.g., a static token) has been saved at the custodian device 104 and a second token (e.g., a dynamic token) has been saved at the cloud-based service 106 for the source device 102.

At 502, the source device 102 may monitor a timer associated with an expiry period for the second token (e.g., the dynamic token). For example, the second token may have a certain time duration for which the second token is valid. The monitoring may reveal that a certain amount of that time duration has passed or remains, for example indicating that a new second token of the recovery token may need to be obtained in order for the recovery token pair to be available for use by the target device 112 in the case that the source device 102 is or becomes unavailable.

Based on a result of monitoring the expiry period at 502, the source device 102 may, at 504, transmit to the remote server 110 a request for a refreshed second token (e.g., a request for a dynamic token of the recovery token pair). In some examples, the request may include an EAP-AKA authorization token and the public key of the source device 102 (e.g., a signed pK).

In response to the request, at 506, the remote server 110 may generate a refreshed second token (e.g., a refreshed dynamic token) and, at 508, cipher the refreshed second token using the public key of the source device 102 (e.g., the signed pK). At 510, the remote server 110 may transmit or otherwise provide the ciphered and refreshed second token to the source device 102. The source device 102 may then transmit the refreshed second token to the cloud-based service 106 at 512. The cloud-based service 106 may then replace the existing ciphered second token stored at the cloud-based service 106 with the refreshed second token received from the remote server 110. The timer associated with the expiry period may also be reset based on the refreshed second token.

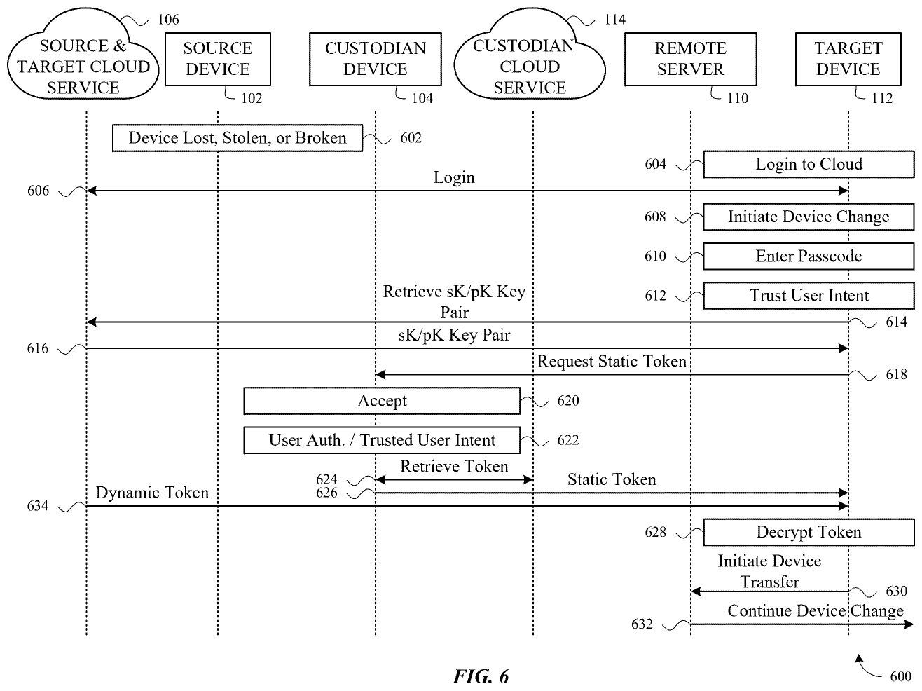

FIG. 6 shows an example signaling flow 600, according to one or more aspects described herein. In one or more embodiments, signaling flow 600 supports one or more aspects of eSIM recovery when a source device is non-functional, as further described herein. Signaling flow 600 generally shows aspects of using a recovery token, and in particular of using a recovery token to transfer an eSIM from an unavailable source device to a target device. In one or more examples, signaling flow 600 generally follows the aspects described with reference to signaling flow 300 and/or signaling flow 400, for example once a first token (e.g., a static token) has been saved at the custodian device 104 and a second token (e.g., a dynamic token) has been saved at the cloud-based service 106 for the source device 102, and/or the second token has been refreshed one or more times according to the signaling flow 500.

At 602, the source device 102 may become unavailable. The user of the source device 102 may decide to acquire a new device, the target device 112, to which the user will transfer the eSIM from the source device 102.

From the target device 112, a user may log in to the OEM cloud at 604 and log in to the cloud-based service 106 at 606. The user of the target device 112 may be the same user as the user of the source device 102, such that the user may use their credentials to access the cloud-based service 106.

At the target device 112, a user may initiate a device change procedure at 608. At 610, the user may enter their passcode into the target device 112. At 612, the user may provide to the target device 112, an indication of an intent of the user (e.g., a trusted user intent) to perform the device change procedure.

At 614, the target device 112 may retrieve the key pair associated with the device change procedure. The key pair may be a private key and a public key (sK and pK). At 616, the target device may receive the key pair.

At 618, the target device 112 may transmit a request, to the custodian device 104 for the first token (e.g., the static token) of the recovery token pair. At 620, the custodian device 104 may accept the request. At 622, a user of the custodian device may provide an indication of authorization to provide the first token to the target device 112. In some examples, the indication may be a user authorization. In some examples, the user may provide to the custodian device 104, an indication of an intent of the user (e.g., a trusted user intent) to trust the target device 112, and thereby authorize the provision of the first token to the target device 112. The custodian device 104 may coordinate with the cloud service 114 to retrieve the first token that was previously stored at the cloud service 114. The first token may be ciphered, as previously discussed, using a public key that was stored in the cloud-based service 106. At 626, the ciphered first token is transmitted or otherwise provided to the target device 112. At 634, the target device 112 also obtains the second token (the dynamic token) from the cloud service 106. The second token may be ciphered using the public key, and decrypted at the target device 112 using the private key of the key pair. 634 may occur before or after 626.

At 628, the target device 112 may decrypt the first token using the private key that was obtained from the cloud service 106 at 616. In some examples, the second token is also ciphered using the public key of the source device 102, and the target device 112 may also decrypt the second token using the corresponding private key that was obtained from the cloud service 106 at 616. Following 628, the target device has both the first token and the second token of the recovery token pair.

At 630, the target device 112 can provide the recovery token pair to the remote server 110 to initiate the device transfer, where the eSIM from the source device 102 that is no longer available is downloaded to the target device 112. From 632, the device change procedure may continue, the device change procedure including the target device 112 receiving the eSIM that was previously for the source device 102.

One or more advantages of performing the signaling flow 600 includes increased security. In some examples, security may be increased because a user (e.g., of the source device 102 and target device 112) signs into a cloud service to initiate the eSIM recovery procedure. Additionally, or alternatively, security may also be increased by sending a notification to the source device 102 in case the source device 102 is still in operation to prevent misuses of the eSIM recovery procedure. Additionally, or alternatively, security may also be increased because the authentic owner of the custodian device 104 may be needed to retrieve the static token. Additionally, or alternatively, security may also be increased because the authentic owner of the source device 102 may be needed to retrieve the private key and/or to decrypt the static token and/or the dynamic token. Additionally, or alternatively, security may also be increased because the static token and the dynamic token are used to perform the recovery procedure, for example where the remote server 110 (e.g., on behalf of the carrier that provided the eSIM to the source device 102) verifies both the static token and dynamic token presented together, but not individually or separately.

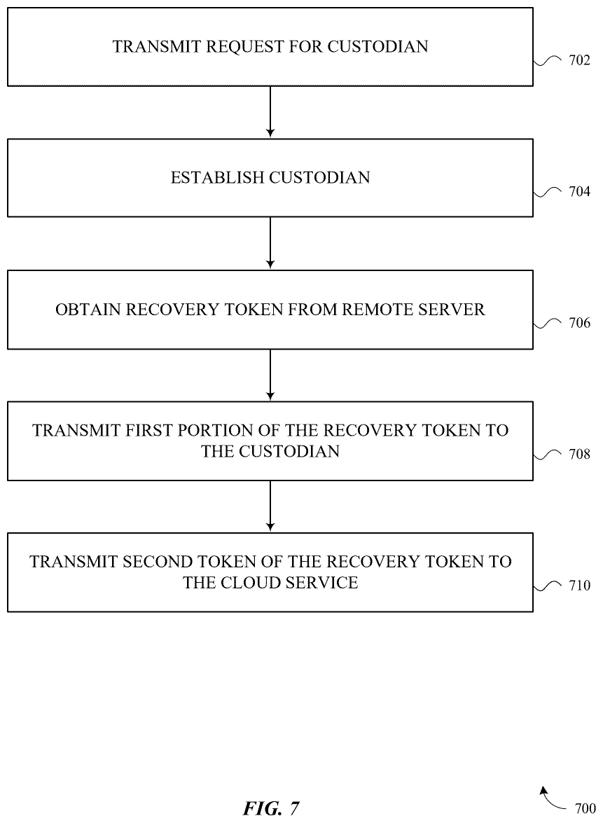

FIG. 7 shows an example method 700 of wireless communication by a UE, according to one or more aspects described herein. In some cases, the UE may be the wireless device 1002 or source device 102 (e.g., a source UE). In some cases, the method 700 may be performed by a processor (e.g., a baseband processor) of the UE. In some embodiments, the baseband processor may include one or more processor cores, and memory that is coupled to the processor core(s). The memory may store instructions that, when executed by the processor core(s), causes the baseband processor to perform the operations of the method 700. As the baseband processor performs the operations of the method 700, the baseband processor may also cause other components of the UE to perform, or discontinue, various operations.

At 702, the method 700 includes transmitting a request for a custodian. In some embodiments, the method 700 includes transmitting, to a custodian UE, a request for the custodian UE to perform as a custodian device of a recovery token for an eSIM of the source UE. In some cases, the operation(s) at 702 may include one or more of the operation(s) described with reference to 202 of FIG. 2, and 308 of FIG. 3.

At 704, the method 700 includes establishing the custodian UE as the custodian. In some embodiments, the method 700 includes receiving, from the custodian UE and responsive to the request, an acceptance of the custodian UE as the custodian device. In some cases, the operation(s) at 704 may include one or more of the operation(s) described with reference to 202 of FIG. 2, and 310 and 312 of FIG. 3.

At 706, the method 700 includes obtaining a recovery token from the remote server. In some embodiments, the method 700 includes obtaining the recovery token from a remote server, the recovery token comprising at least a first token and a second token. In some cases, the operation(s) at 706 may include one or more of the operation(s) described with reference to 412 of FIG. 4.

At 708, the method 700 includes transmitting a first token of the recovery token to the custodian. In some embodiments, the method 700 includes transmitting the first token of the recovery token to the custodian UE for storage. In some cases, the operation(s) at 708 may include one or more of the operation(s) described with reference to 208 of FIG. 2, and 414 of FIG. 4.

At 710, the method 700 includes transmitting a second token of the recovery token to the cloud service. In some embodiments, the method 700 includes transmitting the second token of the recovery token to a cloud service account for storage, the cloud service account being associated with both the source UE and the custodian UE. In some cases, the operation(s) at 710 may include one or more of the operation(s) described with reference to 206 of FIG. 2, and 424 of FIG. 4.

In one or more embodiments, the method further includes periodically requesting, from the remote server, a refreshed token of the recovery token corresponding to the second token of the recovery token; receiving, from the remote server, the refreshed token of the recovery token; and transmitting, to the cloud service account, the refreshed token to replace the second token. In one or more embodiments, the method further includes monitoring a timer associated with refreshing the second token of the recovery token, where the periodic requesting is based at least in part on the monitoring of the timer. In one or more embodiments, the method further includes transmitting, to the remote server, a request message requesting the refreshed token of the recovery token, the request message including the public key of the source device; receiving, responsive to the request message, a response message that includes the refreshed token of the recovery token, the response message encrypted according to the public key; and decrypting the response message using a private key corresponding to the public key.

In one or more embodiments, the method further includes generating a key pair that includes a public key and a private key; transmitting the key pair to the cloud service account for storage, the private key protected by a device passcode; and deleting the private key from the source UE. In one or more embodiments, the method further includes transmitting a first message requesting the recovery token from the remote server, the first message including a trusted embedded universal integrated circuit card signature and a public key for the remote server to utilize to encrypt a second message in response to the first message; and decrypting, using the private key, the second message received in response to the first message, the second message including the first token of the recovery token and the second token of the recovery token.

In some embodiments, the acceptance is performed at the custodian device using one or more inputs from a user of the custodian device. In some embodiments, the one or more inputs from the user of the custodian device include a trusted user intent, a device passcode, or a biometric input.

In some embodiments, the second token of the recovery token is associated with an embargo time duration during which the second token of the recovery token is unavailable to be used. In some embodiments, the first token of the recovery token includes a static token of the recovery token; and the second token of the recovery token includes a dynamic token of the recovery token.

The method 700 may be variously embodied, extended, or adapted, as described in the following paragraphs and elsewhere in this description.

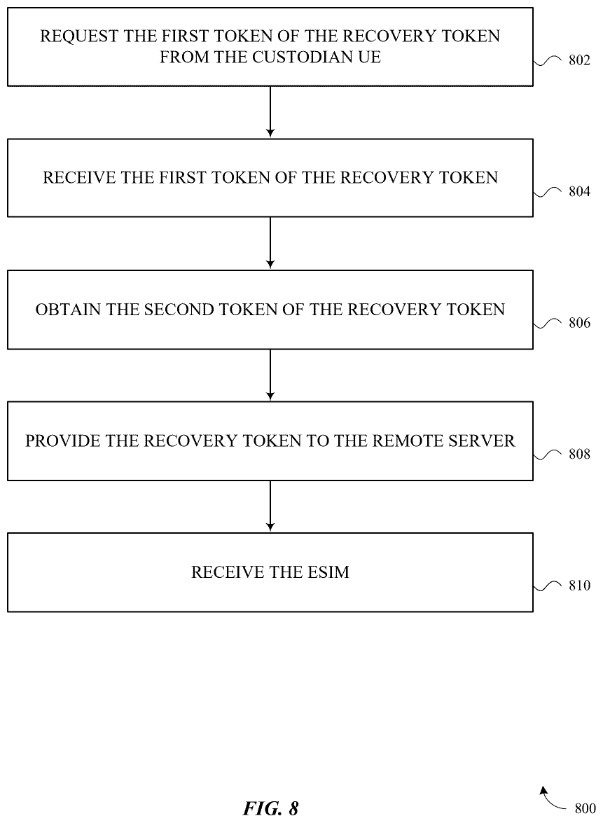

FIG. 8 shows an example method 800 of wireless communication by a UE, according to one or more aspects described herein. In some cases, the UE may be the wireless device 1002 or target device 112 (e.g., a target UE). In some cases, the method 800 may be performed by a baseband processor of the UE. In some embodiments, the baseband processor may include one or more processor cores, and memory that is coupled to the processor core(s). The memory may store instructions that, when executed by the processor core(s), causes the baseband processor to perform the operations of the method 800. As the baseband processor performs the operations of the method 800, the baseband processor may also cause other components of the UE to perform, or discontinue, various operations.

At 802, the method 800 includes requesting the first token of the recovery token from the custodian UE. In some embodiments, the method 800 includes transmitting, to a custodian UE, a request to provide a first token of a recovery token stored at the custodian UE, the recovery token associated with an eSIM of a source UE, the eSIM to be transferred to the target UE. In some cases, the operation(s) at 802 may include one or more of the operation(s) described with reference to 218 of FIG. 2, and 618 of FIG. 6.

At 804, the method 800 includes receiving the first token. In some embodiments, the method 800 includes receiving the first token of the recovery token from the custodian UE, the first token decrypted by the target UE using a private key released at least in part in response to entering a passcode of the source UE. In some cases, the operation(s) at 804 may include one or more of the operation(s) described with reference to 218 of FIG. 2, and 626 of FIG. 6.

At 806, the method 800 includes obtaining the second token of the recovery token. In some embodiments, the method 800 includes obtaining, from the cloud service account associated with both the source UE and the custodian UE, a second token of the recovery token, the second token decrypted by the target UE using the private key. In some cases, the operation(s) at 806 may include one or more of the operation(s) described with reference to 216 of FIG. 2, and 634 of FIG. 6.

At 808, the method 800 includes providing the recovery token to the remote server. In some embodiments, the method 800 includes providing the recovery token, including the first token and the second token, to a remote server. In some cases, the operation(s) at 808 may include one or more of the operation(s) described with reference to 220 of FIG. 2, and 630 of FIG. 6.

At 810, the method 800 includes receiving the eSIM. In some embodiments, the method 800 includes receiving, at the target UE, the eSIM to be transferred to the target UE. In some cases, the operation(s) at 810 may include one or more of the operation(s) described with reference to 220 of FIG. 2, and 632 of FIG. 6.

In one or more embodiments, the method further includes logging in, from the target UE, to the cloud service account for the user of the target UE; and initiating a device change procedure to the target UE. In one or more embodiments, the method further includes providing, by a user of the target UE, a device passcode of the source UE to perform the device change procedure. In one or more embodiments, the method further includes providing, by a user of the target UE, a trusted user intent of the user to perform the device change procedure. In one or more embodiments, the method further includes providing, by a user of the target UE, a biometric input of the user to perform the device change procedure.

In one or more embodiments, the method further includes obtaining, from the cloud service account for the user of the source UE, a key pair that includes a private key and a public key; and decrypting, using the private key, a message from the custodian device, the message encrypted using the public key, and including the first token of the recovery token. In some embodiments, the first token of the recovery token includes a static token of the recovery token; and the second token of the recovery token includes a dynamic token of the recovery token.

The method 800 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 700 or 800. In the context of method 700 or 800, this non-transitory computer-readable media may be, for example, a memory of a UE (such as a memory 1006 of a wireless device 1002 that is a UE, as described herein).

Embodiments contemplated herein include an apparatus having logic, modules, or circuitry to perform one or more elements of the method 700 or 800. In the context of method 700 or 800, this apparatus may be, for example, an apparatus of a UE (such as a wireless device 1002 that is a UE).

Embodiments contemplated herein include an apparatus having one or more processors and one or more computer-readable media, using or storing instructions that, when executed by the one or more processors, cause the one or more processors to perform one or more elements of the method 700 or 800. In the context of method 700 or 800, this apparatus may be, for example, an apparatus of a UE (such as a wireless device 1002 that is a UE, as described herein).

Embodiments contemplated herein include a signal as described in or related to one or more elements of the method 700, or 800.

Embodiments contemplated herein include a computer program or computer program product having instructions, wherein execution of the program by a processor causes the processor to carry out one or more elements of the method 700 or 800. In the context of method 700 or 800, the processor may be a processor of a UE (such as a processor(s) 1004 of a wireless device 1002 that is a UE, as described herein), and the instructions may be, for example, located in the processor and/or on a memory of the UE (such as a memory 1006 of a wireless device 1002 that is a UE, as described herein).

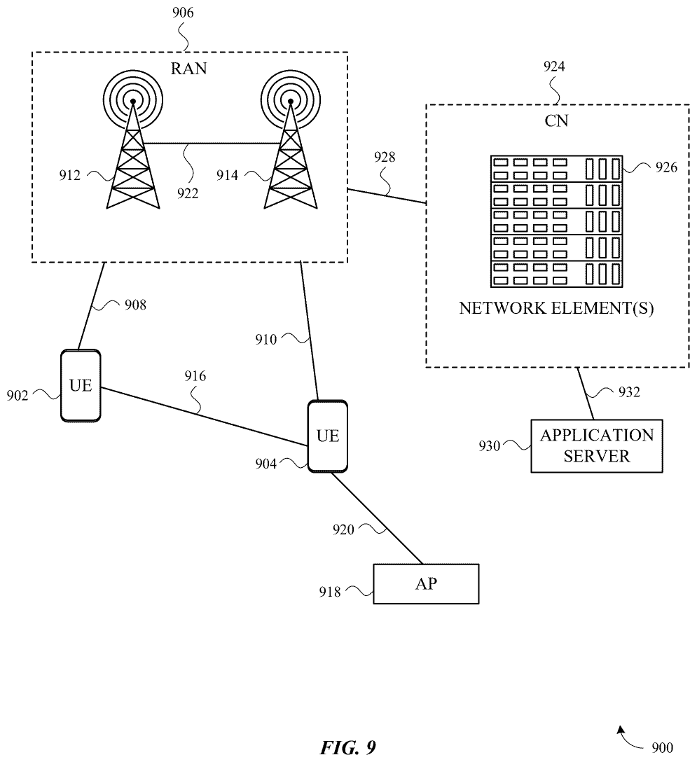

FIG. 9 illustrates an example architecture of a wireless communication system, according to embodiments described herein. The following description is provided for an example wireless communication system 900 that operates in conjunction with the LTE system standards or specifications and/or 5G or NR system standards or specifications, as provided by 3GPP technical specifications.

As shown, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks) but may also comprise any mobile or non-mobile computing device configured for wireless communication.

The UE 902 and UE 904 may be configured to communicatively couple with a RAN 906. In some embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more network devices, such as base station 912 and base station 914, that enable the connection 908 and connection 910.

In this example, the connection 908 and connection 910 are air interfaces to enable such communicative coupling and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a core network (CN) 924.

In some embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In some embodiments where the wireless communication system 900 is an LTE system (e.g., when the CN 924 is an EPC), the interface 922 may be an X2 interface. The X2 interface may be defined between two or more network devices of a RAN (e.g., two or more eNBs and the like) that connect to an EPC, and/or between two eNBs connecting to the EPC. In some embodiments where the wireless communication system 900 is an NR system (e.g., when CN 924 is a 5GC), the interface 922 may be an Xn interface. The Xn interface is defined between two or more network devices of a RAN (e.g., two or more gNBs and the like) that connect to the 5GC, between a base station 912 (e.g., a gNB) connecting to the 5GC and an eNB, and/or between two eNBs connecting to the 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In some embodiments, the CN 924 may be an EPC, and the RAN 906 may be connected with the CN 924 via an S1 interface 928. In some embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In some embodiments, the CN 924 may be a 5GC, and the RAN 906 may be connected with the CN 924 via an NG interface 928. In some embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

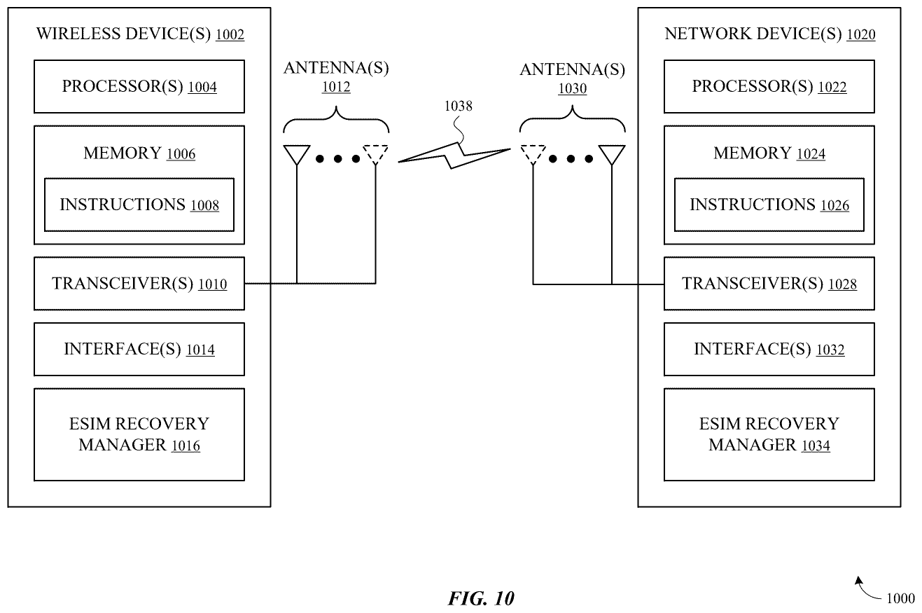

FIG. 10 illustrates an example system 1000 for performing the signaling 1038 between wireless device(s) 1002 and network device(s) 1020, according to embodiments described herein. The system 1000 may be a portion of a wireless communication system as herein described. The wireless device(s) 1002 may be, for example, one or more UEs of a wireless communication system. For example, a first of wireless device(s) 1002 may be a source device 102, a second of wireless device(s) 1002 may be a target device 112, and a third of wireless device(s) 1002 may be a custodian device 104. The network device(s) 1020 may be, for example, one or more of a base station (e.g., an eNB or a gNB) or a radio head of a wireless communication system, and may provide a channel path between the one or more wireless device(s) 1002 and one or more remote server(s) (e.g. remote server 110) or cloud services (e.g., cloud-based service 106 or cloud service 114).

The wireless device(s) 1002 may include one or more processor(s) 1004. The processor(s) 1004 may execute instructions such that various operations of the wireless device(s) 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device(s) 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device(s) 1002 may include one or more transceiver(s) 1010 (also collectively referred to as a transceiver 1010) that may include radio frequency (RF) transmitter and/or receiver circuitry that use the antenna(s) 1012 of the wireless device(s) 1002 to facilitate signaling (e.g., the signaling 1038) to and/or from the wireless device(s) 1002 with other devices (e.g., the network device(s) 1020) according to corresponding RATs.

The wireless device(s) 1002 may include one or more antenna(s) 1012 (e.g., one, two, four, eight, or more). For embodiments with multiple antenna(s) 1012, the wireless device(s) 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device(s) 1002 may be accomplished according to precoding (or digital beamforming) that is applied at the wireless device(s) 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In some embodiments having multiple antennas, the wireless device(s) 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device(s) 1002 may include one or more interface(s) 1014. The interface(s) 1014 may be used to provide input to or output from the wireless device(s) 1002. For example, wireless device(s) 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device(s) 1002 may include eSIM recovery manager 1016. The eSIM recovery manager 1016 may be implemented via hardware, software, or combinations thereof. For example, the eSIM recovery manager 1016 may be implemented as a processor, circuit, and/or instructions 1008 stored in the memory 1006 and executed by the processor(s) 1004. In some examples, the eSIM recovery manager 1016 may be integrated within the processor(s) 1004 and/or the transceiver(s) 1010. For example, the eSIM recovery manager 1016 may be implemented by a combination of software components (e.g., executed by a DSP or a general processor) and hardware components (e.g., logic gates and circuitry) within the processor(s) 1004 or the transceiver(s) 1010.

The eSIM recovery manager 1016 may be used for various aspects of the present disclosure, for example, aspects of FIGS. 1-9, from a wireless device or UE perspective. The eSIM recovery manager 1016 may be configured, for example, to transmit, to a custodian UE, a request for the custodian UE to perform as a custodian device of a recovery token for an eSIM of the source UE; receive, from the custodian UE and responsive to the request, an acceptance of the custodian UE as the custodian device; obtain the recovery token from a remote server, the recovery token comprising at least a first token and a second token; transmit the first token of the recovery token to the custodian UE for storage; and transmit the second token of the recovery token to a cloud service account for storage, the cloud service account being associated with both the source UE and the custodian UE. Alternatively, the eSIM recovery manager 1016 may be configured, for example, to transmit, to a custodian UE, a request to provide a first token of a recovery token stored at the custodian UE, the recovery token associated with an eSIM of a source UE, the eSIM to be transferred to the target UE; receive the first token of the recovery token from the custodian UE, the first token decrypted by the target UE using a private key released at least in part in response to entering a passcode of the source UE; obtain, from the cloud service account associated with both the source UE and the custodian UE, a second token of the recovery token, the second token decrypted by the target UE using the private key; provide the recovery token, including the first token and the second token, to a remote server; and receive, at the target UE, the eSIM to be transferred to the target UE.

The network device(s) 1020 may include one or more processor(s) 1022. The processor(s) 1022 may execute instructions such that various operations of the network device(s) 1020 are performed, as described herein. The processor(s) 1022 may include one or more baseband processors implemented using, for example, a CPU, a DSP, an ASIC, a controller, an FPGA device, another hardware device, a firmware device, or any combination thereof configured to perform the operations described herein.

The network device(s) 1020 may include a memory 1024. The memory 1024 may be a non-transitory computer-readable storage medium that stores instructions 1026 (which may include, for example, the instructions being executed by the processor(s) 1022). The instructions 1026 may also be referred to as program code or a computer program. The memory 1024 may also store data used by, and results computed by, the processor(s) 1022.

The network device(s) 1020 may include one or more transceiver(s) 1028 (also collectively referred to as a transceiver 1028) that may include RF transmitter and/or receiver circuitry that use the antenna(s) 1030 of the network device(s) 1020 to facilitate signaling (e.g., the signaling 1038) to and/or from the network device(s) 1020 with other devices (e.g., the wireless device(s) 1002) according to corresponding RATs.

The network device(s) 1020 may include one or more antenna(s) 1030 (e.g., one, two, four, or more). In some embodiments having multiple antenna(s) 1030, the network device(s) 1020 may perform MIMO, digital beamforming, analog beamforming, beam steering, etc., as has been described.

The network device(s) 1020 may include one or more interface(s) 1032. The interface(s) 1032 may be used to provide input to or output from the network device(s) 1020. For example, network device(s) 1020 of a RAN (e.g., a base station, a radio head, etc.) may include interface(s) 1032 made up of transmitters, receivers, and other circuitry (e.g., other than the transceiver(s) 1028/antenna(s) 1030 already described) that enables the network device(s) 1020 to communicate with other equipment in a network, and/or that enables the network device(s) 1020 to communicate with external networks, computers, databases, and the like for purposes of operations, administration, and maintenance of the network device(s) 1020 or other equipment operably connected thereto.

The network device(s) 1020 may include at least one eSIM recovery manager 1034. The eSIM recovery manager 1034 may be implemented via hardware, software, or combinations thereof. For example, the eSIM recovery manager 1034 may be implemented as a processor, circuit, and/or instructions 1026 stored in the memory 1024 and executed by the processor(s) 1022. In some examples, the eSIM recovery manager 1034 may be integrated within the processor(s) 1022 and/or the transceiver(s) 1028. For example, the eSIM recovery manager 1034 may be implemented by a combination of software components (e.g., executed by a DSP or a general processor) and hardware components (e.g., logic gates and circuitry) within the processor(s) 1022 or the transceiver(s) 1028.

The eSIM recovery manager 1034 may be used for various aspects of the present disclosure, for example, aspects of FIGS. 1-9, from a network device perspective (e.g., some or all aspects of a remote server and/or custodian cloud service).

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein but may be modified within the scope and equivalents of the appended claims.

1. A processor comprising a memory and configured to:
transmit a request for a custodian user equipment (UE) to perform as a custodian device of a recovery token for an embedded subscriber identity module (eSIM) of a source UE;
receive, responsive to the request, an acceptance of the custodian UE as the custodian device;
receive the recovery token from a remote server, the recovery token comprising at least a first token and a second token;
transmit the first token of the recovery token for storage at the custodian UE; and
transmit the second token of the recovery token for storage in a cloud service account, the cloud service account being associated with both the source UE and the custodian UE.

2. The processor of claim 1, further configured to:
periodically request, from the remote server, a refreshed token of the recovery token corresponding to the second token of the recovery token;
receive the refreshed token corresponding to the second token; and
transmit the refreshed token to replace the second token at the cloud service account.

3. The processor of claim 2, further configured to:
monitor a timer associated with refreshing the second token of the recovery token, wherein the periodic request is based at least in part on the monitoring of the timer.

4. The processor of claim 2, further configured to:
transmit a request message requesting the refreshed token of the recovery token from the remote server, the request message including a public key of the source UE;
receive, responsive to the request message, a response message that includes the refreshed token of the recovery token, the response message encrypted according to the public key; and
decrypt the response message using a private key corresponding to the public key.

5. The processor of claim 1, further configured to:
generate a key pair that includes a public key and a private key;
transmit the key pair to the cloud service account for storage, the private key protected by a device passcode; and
delete the private key from the source UE.

6. The processor of claim 5, further configured to:
transmit a first message requesting the recovery token from the remote server, the first message including a trusted embedded universal integrated circuit card signature and the public key for the remote server to utilize to encrypt a second message in response to the first message; and
decrypt, using the private key, the second message received in response to the first message, the second message including the first token of the recovery token and the second token of the recovery token.

7. The processor of claim 1, wherein the acceptance is performed at the custodian UE using one or more inputs from a user of the custodian UE.

8. The processor of claim 7, wherein the one or more inputs from the user of the custodian UE comprise a trusted user intent, a device passcode, or a biometric input.

9. The processor of claim 1, wherein the first token of the recovery token is associated with an embargo time duration during which the second token of the recovery token is unavailable for use.

10. The processor of claim 1, wherein:
the first token of the recovery token comprises a static token of the recovery token; and
the second token of the recovery token comprises a dynamic token of the recovery token.

11. A method of wireless communication at a target user equipment (UE), comprising:
transmitting, to a custodian UE, a request to provide a first token of a recovery token stored at the custodian UE, the recovery token associated with an embedded subscriber identity module (eSIM) of a source UE, the eSIM to be transferred to the target UE;
receiving the first token of the recovery token from the custodian UE, the first token decrypted by the target UE using a private key released at least in part in response to entering a passcode of the source UE;
obtaining, from a cloud service account associated with both the source UE and the custodian UE, a second token of the recovery token, the second token decrypted by the target UE using the private key;
providing the recovery token, including the first token and the second token, to a remote server; and
receiving, at the target UE, the eSIM to be transferred to the target UE.

12. The method of claim 11, further comprising:
logging in, from the target UE, to the cloud service account for a user of the target UE; and
initiating a device change procedure from the source UE to the target UE.

13. The method of claim 12, further comprising:
providing, by the user of the target UE, a device passcode of the source UE to perform the device change procedure.

14. The method of claim 12, further comprising:
providing, by the user of the target UE, a trusted user intent of the user to perform the device change procedure.

15. The method of claim 12, further comprising:
providing, by the user of the target UE, a biometric input of the user to perform the device change procedure.

16. The method of claim 11, further comprising:
obtaining, from the cloud service account, a key pair that includes a private key and a public key; and
decrypting, using the private key, a message from a custodian device, the message encrypted using the public key, and including the first token of the recovery token.

17. The method of claim 11, wherein:
the first token of the recovery token comprises a static token of the recovery token; and
the second token of the recovery token comprises a dynamic token of the recovery token.

18. A method of wireless communication at a source user equipment (UE), comprising:
transmitting, to a custodian UE, a request for the custodian UE to perform as a custodian device of a recovery token for an embedded subscriber identity module (eSIM) of the source UE;
receiving, from the custodian UE and responsive to the request, an acceptance of the custodian UE as the custodian device;
obtaining the recovery token from a remote server, the recovery token comprising at least a first token and a second token;
transmitting the first token of the recovery token to the custodian UE for storage; and
transmitting the second token of the recovery token to a cloud service account for storage, the cloud service account being associated with both the source UE and the custodian UE.

19. The method of claim 18, further comprising:
periodically requesting, from the remote server, a refreshed token of the recovery token corresponding to the second token of the recovery token;
receiving, from the remote server, the refreshed token corresponding to the second token; and
transmitting, to the cloud service account, the refreshed token to replace the second token.

20. The method of claim 19, further comprising:
monitoring a timer associated with refreshing the second token of the recovery token, wherein the periodic requesting is based at least in part on the monitoring of the timer.
